(19) United States
(12) Patent Application Publication
(10) Pub. No.: US 2014/0278799 A1
(43) Pub. Date: Sep. 18, 2014

(54) AUTOMATED IDENTIFICATION OF MARKETING OPPORTUNITIES BASED ON STORED MARKETING DATA

(71) Applicant: Bookigee, Inc., Miami, FL (US)

(72) Inventor: Kristen McLean, Miami, FL (US)

(73) Assignee: Bookigee, Inc., Miami, FL (US)

(21) Appl. No.: 14/214,589

(22) Filed: Mar. 14, 2014

Related U.S. Application Data
(60) Provisional application No. 61/782,258, filed on Mar. 14, 2013.

(51) Int. Cl. G06Q 30/02

(52) U.S. Cl. CPC G06Q 30/0204
USPC 705/7.33

(57) ABSTRACT

A computer system for identifying one or more marketing opportunities for a target product, based on stored marketing data, comprises a processing unit programmed for defining a target product having one or more characteristics, defining at least one existing comparable product that matches one or more characteristics of the target product, reading social media data and sales data for the target and comparable products, calculating one or more marketing opportunities for the target product based on the data that was read, ranking the one or more marketing opportunities for the target product based on the stored marketing data, which comprises consumer behavior data, such that a ranking score is generated for each marketing opportunity, and displaying the one or more marketing opportunities and the corresponding rankings scores for each marketing opportunity.

### CROSS-REFERENCE TO RELATED APPLICATIONS

This patent application claims priority to provisional patent application No. 61/782,258 filed Mar. 14, 2013 and entitled “Automated Identification of Marketing Opportunities Based on Stored Marketing Data.” Provisional patent application No. 61/782,258 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to electronic commerce and, more specifically, to automated processes for identifying marketing opportunities for facilitating electronic commerce.

### BACKGROUND

Whereas in the past, the book publishing industry was largely controlled by a small number of book publishers, in recent years various tools have arisen for facilitating publishing by small groups and self-publishing by individual authors. These tools allow small book publishers and individual authors access to the services necessary for operating a viable book-based business, including producing books, printing books, selling books and delivering books. Consequently, today, publishers of many sizes, including self-published authors and small presses can compete with large publishing houses in the book business.

One aspect of the book publishing business that has remained largely out of reach for all but the largest publishers, however, is good analysis of real-time consumer behavior, sales, and marketing opportunities to drive business growth. The multiple streams of data which would make such an analysis accessible and cost effective—sales data, social media data, census data, consumer research, product data, mobile usage data—are highly distributed and controlled by multiple entities. Large expenses are often associated with building a data team capable of doing this market analysis, and additionally, the costs of securing data are beyond the reach of all but the biggest publishers. Such analysis gives large publishers a significant industry advantage when it comes to acquiring, marketing, and selling their books. Therefore, the high costs of market intelligence in the book publishing industry act as a barrier to entry for many small to mid-sized publishers, as well as for self-published authors, who do not have significant resources to devote to the promotion of their products.

Therefore, a need exists for improvements over the prior art, and more particularly for more efficient methods and systems for identifying marketing opportunities for facilitating electronic commerce, especially in the book publishing industry.

### SUMMARY

A computer system for identifying one or more marketing opportunities for a target product is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a computer system for identifying one or more marketing opportunities for a target product, based on stored marketing data, comprises a network connection device communicatively coupled with a communications network, a memory storage for storing data, and a processing unit coupled to the memory storage and the network connection device. The processing unit is programmed for defining a target product having one or more characteristics, defining at least one existing comparable product that matches one or more characteristics of the target product, reading, via the communications network, social media data and sales data for the target product, reading, via the communications network, social media data and sales data for the comparable product, calculating one or more marketing opportunities for the target product based on the data that was read, ranking the one or more marketing opportunities for the target product based on the stored marketing data, which comprises consumer behavior data, such that a ranking score is generated for each marketing opportunity, and displaying the one or more marketing opportunities and the corresponding rankings scores for each marketing opportunity.

### BRIEF DESCRIPTION OF THE DRAWINGS

The accompanying drawings, which are incorporated in and constitute a part of this disclosure, illustrate various example embodiments. In the drawings:

FIG. 1 is a block diagram of an operating environment that supports the automatic provision of marketing opportunities for a target product, according to an example embodiment;

FIG. 2A is a diagram showing the data flow of the process for automatic provision of marketing opportunities for a target product, according to an example embodiment;

FIG. 2B is a diagram showing the data flow of the algorithm used to determine marketing opportunities for a target product, according to an example embodiment;

FIG. 3A is a flow chart of a method for the automatic provision of marketing opportunities for a target product, according to an example embodiment;

FIG. 3B is an illustration of a sample display of marketing opportunities for a target product, according to an example embodiment;

FIG. 4 is a block diagram of a system including a computing device, according to an example embodiment.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Disclosed methods provide for automatic identification of one or more marketing opportunities for a target product, based on stored industry and consumer marketing data, thereby solving the above-described problem by using an automated process that aids publishers and others (such as agents, authors, or other inquiry agents) in identifying and, taking advantage of, marketing and sales opportunities for the target product. The systems and methods of the present invention leverage the availability of book sales data, social network data and various consumer data to provide a quick and easy way for a publishers and self published authors to obtain automated marketing advice. Further, the systems and methods of the present invention improve over the prior art by providing a publisher or self-published author, with limited resources, access to affordable marketing. Lastly, the systems and methods of the present invention provide analytics of marketing, sales and consumer data directly to a publisher or self-published author, which may be used in making marketing decisions.

FIG. 1 is a block diagram of an operating environment 100 that supports the automatic provision of marketing opportunities for a target product, such as an electronic book, a conventional paper book or a similar product, according to an example embodiment. In further embodiment, the operating environment 100 may support the automatic provision of marketing opportunities for other products, including consumer packaged goods, as well as creative content such as music, movies, television shows, mobile apps, etc.

The environment 100 may comprise multiple client computers 120, 122 and a server 102 communicating via a communications network 106. Each of the client computers 120, 122 and server 102 may be connected either wirelessly or in a wired or fiber optic form to the communications network 106. Client computers 120, 122 and server 102 may each comprise a computing device 400, described below in greater detail with respect to FIG. 4. FIG. 1 shows that client computers 120, 122 may comprise mobile computing devices such as cellular telephones, smart phones or tablet computers, or other computing devices such as a desktop computer, laptop, game console, tablet computer, for example. Communications network 106 may be a packet switched network, such as the Internet, or any local area network, wide area network, enterprise private network, cellular network, phone network, mobile communications network, or any combination of the above.

Environment 100 may be used when multiple clients 110, 112 engage with server 102 to obtain marketing advice based on stored marketing data. Clients 110, 112 may be self-published authors, agents, publishers, or other industry professionals, which are collectively referred to as inquiry agents. Data repository 170 refers to a third party entity that creates, stores or collects relevant industry data, such as sales data, social networking data census data, consumer research, product data, mobile usage data, consumer behavior data, and other types of specific market data pertaining to consumer behavior. Social network 180 refers to an online provider of conventional social network services to consumers 110, 112, such as Facebook, LinkedIn, Instagram, Pinterest, WhatsApp and Twitter. Each client computer 120, 122 may connect directly or indirectly to server 102, social network 180, and repository 170, as defined in method 300 below.

Data repository 170, social media network 180 and server 102 area each associated with a database, such as database 104 for server 102. Each of the databases may hold social media data, which may include, for each user account, product account or social media account, the total number of friends or followers of the account, the number of social media updates (such as text updates, tweets, photos, etc.) of the account, the number of social media endorsements or likes of the account, or any of the data above divided or categorized by time, geographic region, density (i.e., the number of items divided by time, placement on an online location, or geographic region) and virality (i.e., the extent—by numbers—to which an item has become viral or able to spread via the Internet). Each of the databases may also hold sales data, which may include, for each product, the total number of sales of each version of the product (such as printed books versus electronic books), library circulation data, or any of the data above divided or categorized by time, geographic region, density and virality. In addition, these databases may also include census data, consumer research, product data, mobile usage data, and other types of specific market data pertaining to consumer behavior.

FIG. 1 shows an embodiment of the present invention wherein networked computing devices 120, 122 interact with server 102, social network 180 and repository 104 over the network 106. Server 102 includes a software engine that delivers applications, data, program code and other information to networked computing devices 120, 122. The software engine of server 102 may perform other processes such as transferring multimedia data in a stream of packets that are interpreted and rendered by a software application as the packets arrive. It should be noted that although FIG. 1 shows only two networked computing devices 120, 122, the system of the present invention supports any number of networked computing devices connected via network 106.

Server 102 includes program logic 150 comprising computer source code, scripting language code or interpreted language code that is compiled to produce executable file or computer instructions that perform various functions of the present invention. In another embodiment, program logic 150 may be distributed among more than one of server 102, computers 120, 122, or any combination of the above. In yet another embodiment, program logic 150 may comprise a programming module, as described in FIG. 4 below.

Note that although server 102 is shown as a single and independent entity, in one embodiment of the present invention, the functions of server 102 may be integrated with another entity, such as one of the client computers or one or more of 170, 180. Further, server 102 and its functionality, according to a preferred embodiment of the present invention, can be realized in a centralized fashion in one computer system or in a distributed fashion wherein different elements are spread across several interconnected computer systems.

FIG. 2A is a diagram showing the data flow 200 of the process for automatic provision of marketing opportunities for a target product, according to an example embodiment. FIG. 2A depicts the transfer of data from, for example, inquiry agent 110 to server 102, namely, the selection or identification of a target product 202 and a comparable product 204. The target product 202 may, for example, comprise a printed book or an electronic book. Further, the comparable product may match one or more of the following characteristics of the target product: genre, subject, category, author, region, related group, and any literary prizes bestowed upon the book. In one embodiment, the inquiry agent 110 selects or identifies a target product 202 to server 102 via an online graphical user interface (executing on the device 120 of agent 110) by clicking on a displayed selection or selecting a selection via a pull down menu. In another embodiment, the sever 102—in an automated fashion—finds a comparable product 204 (because it matches one or more of the following characteristics of the target product: genre, subject, category, author, region, related group, and any literary prizes bestowed upon the book). Thereafter, the server 102, via the network 106, displays one or more comparable products 204 for the inquiry agent 110 to select via the graphical user interface executing on the device 120 of agent 110.

Consequently, the server 102 collects sales data and social network data (as defined above) from social network 180 and/or data repository 170. Using the data it has collected, as well as other data that may be present in database 104, the server 102 then executes the calculations and algorithms for the method for automatic provision of marketing opportunities for a target product, as defined in FIGS. 3A and 3B below. As a result of the execution of the calculations and algorithms, the server 102 sends marketing advice 206 to the author 110 for display on the graphical user interface executing on the device 120 of agent 110.

The marketing advice 206 may comprise marketing opportunities, sales opportunities, or customer development opportunities for the target product based on the data that was read by server 102. Marketing advice 206 may comprise one or more text strings that define what the inquiry agent 110 may do to market his target product 202, wherein the text string may include an action, a social media indicator and geographic indicia, such as the text strings “Create a Twitter account in New York City,” or “Start an author tour in Miami.” The marketing advice 206 may also comprise a ranking of the one or more marketing opportunities for the target product based on stored marketing data, which comprises consumer behavior data. In one embodiment, the marketing advice 206 may display the marketing opportunities and the corresponding rankings in range of tables, lists, charts and geographic maps, such as a map of weighted circles and/or a ranked text list.

FIG. 2B is a diagram showing the data flow of the algorithm 280 used to determine marketing opportunities for a target product 202, according to an example embodiment. FIG. 2B depicts the data inputs and outputs for the algorithm 280 used to determine marketing opportunities for a target product 202. FIG. 2B shows that the algorithm 280 reads the social network data 252 (received from social network 180, for example) and sales data 254 (received from data repository 170, for example). FIG. 2B also shows that the algorithm 280 reads, or has already saved, stored marketing data 256, as well as consumer behavior data 257. In one embodiment, the stored marketing data 256 includes consumer behavior data. FIG. 2B further shows that algorithm 280 outputs marketing advice 206, which may comprise marketing opportunities, sales opportunities, or customer development opportunities for the target product.

FIG. 3A is a flow chart of a method for the automatic provision of marketing opportunities for a target product, according to an example embodiment. FIG. 3A depicts the actions of an example inquiry agent 110 attempting to obtain marketing advice and analytics of marketing and sales data for the purpose of increasing sales of his target product.

Method 300 may begin at stage 302 wherein the inquiry agent 110 provides an identification of his target product 202, as well as a comparable product 204, to server 102 (as discussed above with reference to FIG. 2A). Next, in optional step 304, the inquiry agent 110 defines which of the aforementioned data from the comparable product 204 to compare to the target product 202. In certain cases, the comparable product 204 may only match the target product 202 in a limited way, such as by genre or location (for example). In these cases, the inquiry agent 110 may specify, in this step, that the algorithm 280 should only compare certain specified characteristics (such as genre and location) of the comparable product 204 to the target product 202. This allows for a more precise comparison.

In one embodiment of step 304, the inquiry agent 110 selects or identifies a certain specified characteristics to server 102 via an online graphical user interface (executing on the device 120 of agent 110) by clicking on a displayed selection or selecting a selection via a pull down menu. In another embodiment, the sever 102—in an automated fashion—determines the certain specified characteristics by doing a comparison of the target product 202 and comparable product 204.

Next, in step 306, the server 102 collects sales data 254 and social network data 252 (as defined above) from social network 180 and/or data repository 170. Using the data it has collected, as well as other data that may be present in database 104 (such as stored marketing data 256), the server 102 then executes the calculations and algorithms of steps 308-318.

In step 308, sales data of the target product 202 and comparable product 204 are divided into geographic buckets, wherein each geographic bucket corresponds to a geographic area, such as a zip code, area code, defined region, defined marketing area “DMA”, etc. Also in step 308, social media data, such as followers, friends, updates, etc., are divided into the same geographic buckets. In step 310, various data in each geographic bucket is calculated. In one embodiment, the following three pieces of data are calculated for each geographic bucket:

[% of sales of target product in that bucket]

[% of sales of comparable product in that bucket]

[% of target product audience (as defined by social media metrics) in that bucket]

wherein the target product audience corresponds to the target audience for the author of the product, the product itself, a series of products of which the target product is a member, etc.

In step 312, using the data calculated in step 310, for each geographic bucket, an opportunity metric (i.e., a value, such as whole numbers from 0 to 3) is assigned to each item according to a reference such as a table, a set of rules, a lookup table, etc. That is, for every combination of values for the data calculated in step 310 for a geographic bucket, the reference provides a corresponding opportunity metric. Further, if the opportunity metric is higher than a threshold (such as higher than 1), the reference also includes a corresponding marketing opportunity. An example lookup table that shows a correspondence between the values calculated in step 310, opportunity metrics and marketing opportunities is shown below.

| % of sales | % of sales of | | | |
|---|---|---|---|---|
| of target | comparable | % of target | Opportunity | Marketing |
| product | product | audience | metric | opportunity |
| 30 | 40 | 30 | 3 | Launch |
| | | | | Foursquare |
| | | | | giveaway |
| 25 | 35 | 25 | 3 | Initiate |
| | | | | author tour |
| 35 | 45 | 35 | 3 | Launch local |
| | | | | Twitter meme |
| 20 | 30 | 20 | 2 | Targetted |
| | | | | Facebook ads |
| 30 | 10 | 10 | 1 | None |

Thus, the reference table above shows that, for a particular geographic bucket, if the % of sales of the target product is 30, the % of sales of the comparable product is 40 and the % of the target product audience is 40, the opportunity metric is 3, which is above the predefined threshold. Since the opportunity metric is above the predefined threshold, the reference table also advises that a giveaway should be launched on the FourSquare social media site, for that particular geographic bucket. The reference table above also shows that, for a particular geographic bucket, if the % of sales of the target product is 30, the % of sales of the comparable product is 10 and the % of the target product audience is 10, the opportunity metric is 1, which is below the predefined threshold. Since the opportunity metric is below the predefined threshold, the reference table does not advise any marketing opportunities, for that particular geographic bucket.

It should be noted that the purpose of the reference or lookup table above is to calculating one or more marketing opportunities for the target product by identifying those marketing aspects of the comparable product which resulted in sales of the comparable product, but which marketing aspects are not being implemented by the target product. Further, the reference or lookup table above may comprise a least a portion of the stored marketing data 256.

In step 314, server 102 ranks those marketing opportunities identified in step 312, based on a variety of data (such as sales data, social media data, demographic data, stored marketing data 256, etc.). For example, ranking may be based on the percent of an existing audience of the target product in each geographic bucket, as measured by social media metrics, such as number of followers, number of tweets or social media mentions/impressions, etc. Thus, in this example, if there are two geographic buckets (e.g., cities) with the same opportunity metric, the city with the higher percentage of social media followers for the target product achieves the higher rank in step 314. The data used to perform the ranking algorithm of step 314 may comprise a least a portion of the stored marketing data 256.

In step 316, server 102 executes a second ranking process by adding weights to the rankings of the marketing opportunities calculated in step 314. The weights may be based on a variety of data (such as sales data, social media data, demographic data, etc.). In one example, the weights may be placed based on density, virality, and influence of the geographic bucket or consumer grouping relative to the genre of the target product. Weights may be assigned on aggregated data on genre target product sales to define which target geographic or consumer groupings tend to sell better for specific genres. The data used to perform the ranking algorithm of step 316 may comprise a least a portion of the stored marketing data 256.

In step 318, server 102 executes a second ranking process by adding additional weights to the marketing opportunities that were weighted in step 316. The weights may be based on a variety of data. In one example, the weights may be placed based on the relevance of the geographic bucket or consumer grouping to the inquiry agent's location and/or industry position relative to the original inquiry. The data used to perform the ranking algorithm of step 318 may comprise a least a portion of the stored marketing data 256.

In one alternative, the server 102 performs an additional procedure comprising attaching the marketing opportunities calculated above to specific geographic targets within the opportunity area based on a proprietary list of locations that have strong actionability based on a significant collection of retailers, outlets, and fan communities, or other factors that can be activated by the inquiry agent 110 based on past behavior. In another alternative, specific behavioral suggestions are listed for each marketing opportunity based on the profile of the inquiry agent 110. That is, certain factors in the inquiry agent profile such as size of the business, geographic location, familiarity with technology, use of social media, and current marketing sophistication may affect the specific behavioral suggestions are listed for each marketing opportunity.

As a result of the execution of the calculations and algorithms, in step 320, the server 102 sends marketing advice 206 to the inquiry agent 110 for display on his computer 120. In step 322, the marketing advice is displayed on computer 120.

FIG. 3B is an illustration of a sample display of marketing opportunities for a target product, according to an example embodiment. FIG. 3B shows example marketing advice 206 displayed on computer 120. The FIG. 350 depicts a geographic map of weighted circles that correspond to the ranking scores calculated in 314-318. The FIG. 350 shows the largest circle around the city of Miami with a rank of #1 and the advice “Launch FourSquare giveaway,” the second largest circle around the city of L.A. with a rank of #2 and the advice “Initiate author tour,” the second smallest circle around the city of New York City with a rank of #3 and the advice “Launch local Twitter meme,” and the smallest circle around the city of New Orleans with the rank of #4 and the advice of “targeted Facebook ads.” The FIG. 352 shows a ranked text list that reflects the data ranking scores calculated in 314-318.

FIG. 4 is a block diagram of a system including an example computing device 400 and other computing devices. Consistent with the embodiments described herein, the aforementioned actions performed by client computers 120, 122, by server 102 and the entities 170, 180 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for data flows and methods described above. The data flows and methods described above may operate in other environments and are not limited to computing device 400.

With reference to FIG. 4, a system consistent with an embodiment of the invention may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination or memory. System memory 404 may include operating system 405, and one or more programming modules 406. Operating system 405, for example, may be suitable for controlling computing device 400's operation. In one embodiment, programming modules 406 may include, for example, a program module for executing the actions of program logic 150. Furthermore, embodiments of the invention may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. The aforementioned devices are only examples, and other devices may be added or substituted.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 (e.g. a program module) may perform processes including, for example, one or more of data flow 200's and method 300's stages as described above. The aforementioned processes are examples, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer system for identifying one or more marketing opportunities for a target product, based on stored marketing data, wherein the computer system comprises:
a network connection device communicatively coupled with a communications network;
a memory storage for storing data; and
a processing unit coupled to the memory storage and the network connection device, wherein the processing unit is programmed for:
defining a target product having one or more characteristics;
defining at least one existing comparable product that matches one or more characteristics of the target product;
reading, via the communications network, social media data and sales data for the target product;
reading, via the communications network, social media data and sales data for the comparable product;
calculating one or more marketing opportunities for the target product based on the data that was read;
ranking the one or more marketing opportunities for the target product based on the stored marketing data, which comprises consumer behavior data, such that a ranking score is generated for each marketing opportunity; and
displaying, via the communications network, the one or more marketing opportunities and the corresponding ranking scores for each marketing opportunity.

2. The server of claim 1, wherein the target product comprises a printed book or an electronic book.

3. The server of claim 2, wherein the comparable product matches one or more of the following characteristics of the target product: genre, subject, category, author, region, publisher, group, and prize.

4. The server of claim 3, wherein social media data comprises one or more of: number of friends or followers of a product profile, number of social media updates from the product profile, and number of social media endorsements of the product profile.

5. The server of claim 4, wherein social media data may be partitioned according to time, geographic region, density and virality.

6. The server of claim 5, wherein sales data comprises one or more of number of sales of a product and library circulation data of the product.

7. The server of claim 6, wherein sales data may be partitioned according to outlet, time, and geographic region.

8. The server of claim 7, wherein the step of calculating one or more marketing opportunities for the target product based on the data that was read further comprises:
calculating one or more marketing opportunities for the target product by identifying those marketing aspects of the comparable product which resulted in sales of the comparable product, but which marketing aspects are not being implemented by the target product.

9. The server of claim 8, wherein the step of ranking the one or more marketing opportunities for the target product further comprises:
ranking the one or more marketing opportunities based on one or more of the following aspects: a percent of the target product's existing audience in each marketing opportunity, a geographic distance of each marketing opportunity from a hometown of an author of the target product, and density, virality, and influence of each geographic location relative to a genre of the target product.

10. The server of claim 1, wherein the step of displaying the marketing opportunities and the corresponding rankings further comprises displaying a geographic map of weighted circles that correspond to the ranking scores.

11. The server of claim 1, wherein the step of displaying the marketing opportunities and the corresponding rankings further comprises displaying a ranked text list.

12. A computer-readable storage medium storing executable instructions, which, when executed by a computing device, cause the computing device to perform a method for identifying one or more marketing opportunities for a target product, based on stored marketing data, the method comprising:
defining a target product having one or more characteristics;
defining at least one existing comparable product that matches one or more characteristics of the target product;
reading, via the communications network, social media data and sales data for the target product;
reading, via the communications network, social media data and sales data for the comparable product;
calculating one or more marketing opportunities for the target product based on the data that was read;
ranking the one or more marketing opportunities for the target product based on the stored marketing data, which comprises consumer behavior data, such that a ranking score is generated for each marketing opportunity; and
displaying, via the communications network, the one or more marketing opportunities and the corresponding ranking scores for each marketing opportunity.

13. The computer-readable storage medium of claim 12, wherein the target product comprises a printed book or an electronic book.

14. The computer-readable storage medium of claim 13, wherein the comparable product matches one or more of the following characteristics of the target product: genre, subject, category, author, region, publisher, group, and prize.

15. The computer-readable storage medium of claim 14, wherein the step of calculating one or more marketing opportunities for the target product based on the data that was read further comprises:
calculating one or more marketing opportunities for the target product by identifying those marketing aspects of the comparable product which resulted in sales of the comparable product, but which marketing aspects are not being implemented by the target product.

16. The computer-readable storage medium of claim 15, wherein the step of ranking the one or more marketing opportunities for the target product further comprises:
ranking the one or more marketing opportunities based on one or more of the following aspects: a percent of the target product's existing audience in each marketing opportunity, a geographic distance of each marketing opportunity from a hometown of an author of the target product, and density, virality, and influence of each geographic location relative to a genre of the target product.
